(19) United States
(12) Patent Application Publication
(10) Pub. No.: US 2021/0166461 A1
(43) Pub. Date: Jun. 3, 2021

(54) AVATAR ANIMATION

(71) Applicant: Web Assistants GmbH, Zug (CH)

(72) Inventors: Thomas RIESEN, Winterthur (CH); Beat SCHLAEFLI, Ellikon am Rhein (CH)

(73) Assignee: Web Assistants GmbH, Zug (CH)

(21) Appl. No.: 17/257,712

(22) PCT Filed: Jul. 4, 2018
(86) PCT No.: PCT/EP2018/068136

§ 371 Date: Jan. 4, 2021

(51) Int. Cl. G06T 13/40; G06T 1/60; G06T 13/80

(52) U.S. Cl. CPC G06T 13/40; G06T 13/80; G06T 1/60

(57) ABSTRACT

A computer-implemented method for animating an avatar using a data processing device comprises the steps: a) providing a graphics unit which is designed to animate 2-dimensional and/or 3-dimensional objects and which has an interface, via which control data can be transferred to the graphics unit in order to animate the two- and/or three-dimensional objects; b) loading and holding in readiness an avatar in a memory area that can be addressed by the graphics unit; c) providing a receiving unit for receiving control data for animating the avatar; d) continuous and sequential transferring of received control data to the graphics unit; e) animating the avatar by continuous re-calculation of an updated avatar on the basis of the current control data being transferred with subsequent rendering of the avatar in the graphics unit; f) continuous representation of the updated avatar on a display device.

### TECHNICAL FIELD

The invention relates to a computer-implemented method for animating an avatar using a data processing device and to a method for capturing control data for animating an avatar. The invention also relates to a data processing system comprising means for carrying out the methods and to a computer program. The invention likewise relates to a computer-readable storage medium having a computer program.

### PRIOR ART

On account of rapidly progressing digitization, real persons are being increasingly represented by virtual characters or avatars in many areas. In this case, avatars are typically artificial persons or graphic figures which are assigned to a real person in the virtual world.

Avatars may be present, for example, in the form of static images which are assigned to a user in Internet forums and, for the purpose of identification, are each displayed beside contributions to the discussion. Dynamic or animatable avatars which can move and/or the appearance of which can be specifically changed are likewise known. In this case, complex avatars are able to emulate the movements and facial expressions of real persons in a realistic manner.

Avatars are already widespread in computer games. In this case, the user can be specifically represented by an animatable virtual character and can move in the virtual game world. Avatars are also used, in particular, in the film industry, in online support, as virtual assistants, in audiovisual communication, for example in avatar video chats, or for training purposes.

US 2013/0235045 A1 describes, for example, a computer system comprising a video camera, a network interface, a memory unit containing animation software and a model of a 3-D character or avatar. The software is configured such that facial movements are detected in video images of real persons and can be translated into motion data. These motion data are then used to animate the avatar. The animated avatars are rendered as coded video messages which are transmitted, via the network interface, to remote devices and are received there.

However, the disadvantage of such systems is that it is necessary to work with coded video messages which generate accordingly large volumes of data. Real-time animations, in particular on remote devices, are scarcely possible or are possible only with a restricted quality on account of the limited transmission rates via Internet and network connections.

Avatars are also already used in the field of training, in which case they adopt the role of real teachers in video animations or can specifically illustrate complex issues. Such video animations are typically produced in advance by 3-D animation programs and are provided as video clips or video films. During production, avatars or objects are associated with animation data, are directly rendered against a background in the 3-D animation program and are provided as a unit in a video file. The result is therefore completely rendered video files of a defined length with stipulated or unchangeable animation sequences and backgrounds.

However, currently available 3-D animation programs which can be used to animate and present avatars are usually very complex to operate and can therefore be operated only by specialists. In addition, the loading times are usually very long since only completely rendered avatars can be loaded and presented.

Therefore, there is still a need for improved and more flexible solutions for animating and presenting avatars.

### DESCRIPTION OF THE INVENTION

The object of the invention is to provide an improved method for animating an avatar, which method belongs to the technical field mentioned at the outset. In particular, the method is intended to enable real-time animation of an avatar and is preferably intended to provide high-quality animations in a flexible manner with data volumes which are as low as possible.

The achievement of the object is defined by the features of claim 1. According to the invention, a computer-implemented method for animating an avatar using a data processing device comprises the steps of:
a) providing a graphics unit which is designed to animate two-dimensional and/or three-dimensional objects and has an interface, via which control data for animating the two-dimensional and/or three-dimensional objects can be transferred to the graphics unit;
b) loading and keeping an avatar available in a memory area which can be addressed by the graphics unit;
c) providing a receiving unit for receiving control data for animating the avatar;
d) continuously and sequentially transferring received control data to the graphics unit;
e) animating the avatar by continuously recalculating an updated avatar on the basis of the respectively currently transferred control data with subsequent rendering of the avatar in the graphics unit;
f) continuously presenting the updated and rendered avatar on an output device.

According to the invention, the avatar is therefore loaded and kept available in a memory area which can be addressed by the graphics unit before the actual animation. In particular, the avatar is omnipresently available in the memory area during steps d) to f).

Control data for animating the avatar can then be continuously received via the receiving unit and transferred to the graphics unit. In the graphics unit, the avatar which has been loaded in advance is then continuously recalculated and rendered on the basis of the respectively currently transferred control data. The avatar updated and rendered in this manner is presented on an output device.

This method has the great advantage that the avatar as such or the model on which the avatar is based is loaded and kept available independently of the control data. The avatar is preferably loaded completely before the control data in terms of time. In order to animate the available avatar, it suffices to receive the control data and use them to update the avatar. This considerably reduces the volumes of data and enables high-quality real-time applications even in the case of restricted transmission bandwidths. User interactions in real time can accordingly be implemented without any problems using the approach according to the invention.

Since the avatar is available in principle for an unlimited time after loading, it can be animated at any time and for any length of time using control data. It should also be emphasized that the control data can come from different sources, thus making it possible to achieve a high degree of flexibility in the animation. For example, the control data source can be changed without any problems during the ongoing animation of the avatar. It is also possible to specifically influence an animation running on the basis of a particular control data source by means of additional user inputs which generate additional control data.

On account of the continuous presentation of the updated avatar, the latter can be presented without a frame and/or without a background and/or can be cropped as such in principle at any location on an output device, for example a screen.

The approach according to the invention is therefore in clear contrast to video-based animations of avatars during which a complete video rendering of a complete animation sequence with a background and/or predefined frame is carried out before presenting the avatar.

According to one particularly preferred embodiment, the method according to the invention is carried out in a web browser running on the data processing installation. For users, this has the advantage, in particular, that, apart from standard software which is usually present, for example a web browser, no further programs are required, and a computer program which, during execution by a computer, causes the latter to carry out the method according to the invention can be provided as a website. In other words, the computer program which, during execution by a computer, causes the latter to carry out the method according to the invention may be present as a web application.

In the present case, a web browser should be understood as meaning, in particular, a computer program which is designed to present electronic hypertext documents or websites in the World Wide Web. The web browser is designed, in particular, in such a manner that HTML-based documents (HTML=Hypertext Markup Language) and/or CSS-based documents (CSS=Cascading Style Sheets) can be interpreted and presented. The web browser additionally preferably has a runtime environment for programs, in particular a Java runtime environment.

The web browser preferably also has a programming interface which can be used to present 2-D and/or 3-D graphics in the web browser. In this case, the programming interface is preferably designed in such a manner that the presentation can be effected in a hardware-accelerated manner, for example using a graphics processor or a graphics card, and, in particular, can be effected without additional expansions.

Web browsers which have a WebGL programming interface are suitable, for example. Corresponding web browsers are freely available, inter alia Chrome (Google), Firefox (Mozilla), Safari (Apple), Opera (Opera software), Internet Explorer (Microsoft) or Edge (Microsoft).

Steps d)-f) of the method according to the invention can be implemented, for example, by means of the following substeps:
(i) transferring a first received control data record to the graphics unit;
(ii) calculating an updated avatar on the basis of the transferred control data record and rendering the avatar in the graphics unit;
(iii) presenting the updated avatar on an output device;
(iv) transferring a next received control data record to the graphics unit;
(v) repeating steps (ii) to (iv), in particular until a predefined abort condition is satisfied.

In this case, the substeps were carried out, in particular, in the stated order.

In this case, the control data preferably comprise one or more control data records, wherein each control data record defines the avatar at a particular time. This means, in particular, that the control data record(s) define(s) the state of the avatar at a given time. In particular, the control data record(s) directly or indirectly define(s) the positions of the movable control elements of the avatar, for example of bones and/or joints, at a particular time. An indirect definition or stipulation can be effected, for example as explained further below, by means of key images.

According to one particularly preferred embodiment, steps d) to f) and/or substeps (i) to (iv) are carried out in real time. This enables realistic animations and immediate user interactions. However, for special applications, steps d) to f) and/or substeps (i) to (iv) can also take place in a faster or slower manner.

A repetition rate of the respective processes in steps d) to f) and/or of substeps (i) to (iv) is, in particular, at least 10 Hz, in particular at least 15 Hz, preferably at least 30 Hz or at least 50 Hz. The respective processes in steps d) to f) and/or substeps (i) to (iv) preferably take place in a synchronized manner. This makes it possible to achieve particularly realistic real-time animations. In special cases, however, lower repetition rates are also possible.

It is also preferred if the control data have time coding and steps d) to f) and/or substeps (i) to (iv) are executed in sync with the time coding. This enables a time-resolved animation of the avatar, which in turn benefits the closeness to reality.

In the present invention, an “avatar” is understood as meaning an artificial model of a real body or object, for example a living thing. In particular, the term avatar is understood as meaning an artificial person or a graphic figure which can be assigned to a real person in the virtual world. In this case, the avatar may represent the living thing completely or only partially, for example only the head of a person.

The avatar is defined, in particular, as a two-dimensional or three-dimensional virtual model of a body. The model is movable in a two-dimensional or three-dimensional space, in particular, and/or has control elements which can be used to change the form of the virtual model in a defined manner.

In particular, the avatar is based on a skeleton model. However, other models can likewise be used, in principle.

The avatar is particularly preferably defined by a skeleton in the form of a set of hierarchically connected bones and/or joints and a mesh of vertices which is coupled thereto.

The positions of the vertices are typically predefined by a position indication in the form of a two-dimensional or three-dimensional vector. In addition to the position indication, further parameters may also be assigned to the vertices, for example color values, textures and/or assigned bones or joints. The vertices define, in particular, the visible model of the avatar.

The positions of the bones and/or joints are defined, in particular, by two-dimensional or three-dimensional coordinates.

Bones and/or joints are preferably defined in such a manner that they permit predefined movements. For example, a selected bone and/or a selected joint may be defined as a so-called root which can be both shifted in space and can perform rotations. All other bones and/or joints can then be restricted to rotational movements. In this case, each joint and/or each bone can geometrically represent a local coordinate system, wherein transformations of a joint and/or of a bone also affect all dependent joints and/or bones or their coordinate systems.

Corresponding avatars are commercially available from various providers, for example Daz 3D (Salt Lake City, USA) or High Fidelity (San Francisco, USA). However, avatars can also be self-produced in principle, for example using special software, for example Maya or 3ds Max from Autodesk, Cinema4D from Maxon or Blender, an open-source solution.

Preferred data formats for the avatars are JSON, gITF2, FBX and/or COLLADA. These are compatible, inter alia, with WebGL.

It is also preferred if key images (key frames) of the avatar, for example 10-90 key images, are loaded into the memory area and are provided together with the avatar. A key image corresponds to the virtual model of the avatar in a predefined state. If the avatar represents a human body, one key image can present the avatar with an open mouth, for example, whereas another key image presents the avatar with a closed mouth. The movement of opening the mouth can then be achieved by means of a so-called key image animation, which is explained in more detail further below.

However, it is possible to dispense with key images, in principle. This is the case, for example, if the transmission bandwidths are sufficient or if the complexity of the avatar is limited.

In particular, the control data comprise one or more control data records, wherein a control data record defines the avatar at a particular time.

In particular, a control data record contains the coordinates of n bones and/or joints, whereas the avatar comprises more than n bones and/or joints. In other words, a control data record respectively comprises only the coordinates of a limited selection of the bones and/or joints of the avatar. In this case, one of the more than n bones and/or joints of the avatar is assigned, in particular, to each of the n bones contained in a control data record.

According to one particularly preferred embodiment, when calculating the updated avatar, intermediate images are generated by interpolating at least two key images. In this case, one or more intermediate images can be interpolated at intervals of time starting from the key images, thus obtaining a complete and fluid motion sequence without control data for each bone and/or each joint being required for each individual intermediate image. Instead, control data which cause the avatar to carry out a particular movement suffice. In this case, both the strength of the movement and the speed can be predefined. Returning to the example mentioned above, the avatar can be prompted, by means of appropriate control data, to open its mouth, for example. In this case, both the degree of opening and the opening speed can be predefined.

The use of key images makes it possible to considerably reduce the volume of data without noticeably reducing the quality of the animation.

The positions and/or coordinates of a bone and/or joint in the control data or from a control data record are preferably assigned to one or more bones and/or joints of the avatar and/or to one or more key images of the avatar in step e).

For this purpose, at least one key image, in particular a plurality of key images, is/are linked, in particular, to a selected bone and/or joint in the control data or at least one key image, in particular a plurality of key images, is/are linked to the positions and/or coordinates of a selected bone and/or joint in the control data in step e). In this case, a position of a selected bone and/or joint in the control data can be assigned to an intermediate image which is obtained by means of interpolation using the at least one linked key image.

A deviation of the position of a selected bone and/or joint from a predefined reference value defines, in particular, the strength of the influence of the at least one linked key image in the interpolation.

The individual control data are advantageously assigned to the bones and/or joints of the avatar and/or to the key images according to a predefined protocol, wherein the protocol is preferably loaded into the memory area and provided together with the avatar. Both the avatar and the assigned protocol are therefore available for an unlimited time or omnipresently. The data rate with respect to the control data can therefore be minimized.

In the protocol used, the coordinates of a bone and/or joint from the control data or a control data record are preferably assigned to one or more bones and/or joints of the avatar and/or to one or more key images of the avatar.

The control data are present, in particular, in a BVH data format (BVH=Biovision Hierarchy). This is a data format which is known per se, is specifically used for animation purposes and contains a skeleton structure and motion data.

According to one preferred embodiment, steps a) to f) of the method according to the invention are carried out completely on a local data processing installation. In this case, the local data processing installation may be, for example, a personal computer, a portable computer, in particular a laptop or a tablet computer, or a mobile device, for example a mobile telephone with computer functionality (smartphone). The data traffic can be reduced with such an approach since, apart from possible transmission of control data and/or the avatar to be loaded, no additional data interchange between data processing installations is required.

However, for special applications, it is possible for one or more of the individual steps of the method according to the invention to be carried out on different data processing installations.

In particular, the control data, the avatar to be loaded and/or the protocol is/are present at least partially, in particular completely, on a remote data processing installation, in particular a server, and is/are received therefrom via a network connection, in particular an Internet connection, in particular on that local data processing installation on which the method according to the invention is carried out.

In particular, both the control data and the avatar to be loaded and a possible protocol are present on a remote data processing installation.

With this approach, the user can access control data and/or avatars at any time, in principle, independently of the data processing installation which is currently available to the user.

However, in principle, it is also possible for the control data and/or the avatar to be loaded to be present on that local data processing installation on which the method according to the invention is carried out.

In a particularly preferred manner, the avatar to be loaded and/or the control data to be received can be or will be selected in advance using an operating element. The operating element is, for example, a button, a selection field, a text input and/or a voice control unit. This may be provided in a manner known per se via a graphical user interface of the data processing installation.

Such operating elements can be used by the user to deliberately select avatars which are animated using the control data of interest in each case.

In particular, there are further operating elements which can be used to control the animation of the avatar. For example, the animation can be started, paused and/or stopped using the further operating elements. The further operating elements are preferably likewise provided in a graphical user interface of the data processing installation.

In particular, the control elements and the further control elements are HTML and/or CSS control elements.

The avatar is particularly preferably rendered and presented in a scene together with further objects. Realistic animations can therefore be created. The further objects may be, for example, backgrounds, floors, rooms and the like. On account of the method according to the invention, further objects can be integrated in a scene at any time, even in the case of an animation which is already running.

According to one preferred embodiment, two or more avatars are simultaneously loaded and kept available independently of one another and are preferably animated independently of one another using individually assigned control data. This is possible without any problems using the method according to the invention. For example, user interactions or audiovisual communication between a plurality of users can therefore be implemented in an extremely flexible manner.

The updated avatar may, in principle, be presented on any desired output device. For example, the output device may be a screen, a video projector, a hologram projector and/or an output device to be worn on the head (head mounted display), for example video glasses or data glasses.

A further aspect of the present invention relates to a method for capturing control data for animating an avatar using a data processing device, wherein the control data are designed, in particular, for use in a method as described above, comprising the steps of:
a) providing a two-dimensional or three-dimensional virtual model of a body, which can be moved in a two-dimensional or three-dimensional space, wherein the model has control elements which can be used to change the virtual model in a defined manner;
b) capturing the movements and/or changes of a real body in a time-resolved manner;
c) emulating the movements and/or changes of the real body in the virtual model by determining the coordinates of the control elements of the virtual model, which correspond to a state of the real body at a given time, in a time-resolved manner;
d) providing the determined time-resolved coordinates of the control elements as control data.

The method according to the invention for capturing control data makes it possible to generate control data in a flexible manner which can then be used in the above-described method for animating an avatar.

The method is preferably carried out in a web browser running on the data processing installation. In this case, the web browser is designed as described above, in particular, and has the functionalities and interfaces described above, in particular. For users, this in turn has the advantage that, apart from conventionally present standard software, for example a web browser, no further programs are required, and a computer program which, during execution by a computer, causes the latter to carry out the method according to the invention may be present as a web application. Accordingly, it is possible to generate control data for animating avatars in a manner based purely on a web browser.

The web browser preferably has communication protocols and/or programming interfaces which enable real-time communication via computer-computer connections. Web browsers which comply with the WebRTC standard, for example Chrome (Google), Firefox (Mozilla), Safari (Apple), Opera (Opera software) or Edge (Microsoft), are suitable, for example.

In step b), in order to capture the movements and/or changes of the body, it is possible, in principle, to use any desired means which can be used to track the movements and/or changes of the real body. For example, the means may be a camera and/or a sensor.

2-D cameras and/or 3-D cameras are suitable as cameras. 2-D video cameras and/or 3-D video cameras are preferred. In the present case, a 3-D camera is understood as meaning a camera which allows the visual presentation of distances of an object. In particular, this is a stereo camera, a triangulation system, a time of flight measurement camera (TOF camera) or a light field camera. A 2-D camera is accordingly understood as meaning a camera which enables a purely two-dimensional presentation of an object. This may be a monocular camera, for example.

Bending, strain, acceleration, location, position and/or gyro sensors can be used as sensors. In particular, mechanical, thermoelectric, resistive, piezoelectric, capacitive, inductive, optical and/or magnetic sensors are involved. Optical sensors and/or magnetic sensors, for example Hall sensors, are suitable, in particular, for facial recognition. They may be fastened and/or worn at defined locations on the real body and can therefore record and forward the movements and/or changes of the body. For example, sensors can be integrated in items of clothing which are worn by a person whose movements and/or changes are intended to be captured. Corresponding systems are commercially available.

A camera, in particular a 2-D camera, is particularly preferably used in step b), in particular for the purpose of capturing the face of a real person. A video camera is preferably used in this case. It may also be advantageous if, in addition to the camera, one or more sensors are used in step b) to capture the movements and/or changes of the real body. This is advantageous, for example, if control data are intended to be generated for a full-body animation of a person since the body parts below the head can be readily captured using sensors, for example in the form of a sensor suit.

Steps b) to d) are preferably carried out in real time. This makes it possible to generate control data which enable a realistic and natural animation of an avatar.

In particular, the coordinates of all control elements at a defined time form a data record which completely defines the model at the defined time.

In particular, the virtual model for the method for capturing control data comprises fewer control elements than the above-described virtual model of the avatar in the method for animating an avatar. It is therefore possible to reduce the volumes of the control data.

The virtual model is preferably defined by a skeleton model. However, other models are also possible, in principle.

The virtual model is preferably defined by a skeleton in the form of a set of hierarchically connected bones and/or joints and a mesh of vertices which is coupled thereto, wherein the bones and/or joints, in particular, constitute the control elements. In this case, the virtual model for the method for capturing control data comprises fewer bones, joints and vertices than the above-described virtual model of the avatar in the method for animating an avatar.

The virtual model for the method for capturing control data is designed, in particular, such that it has the same number of bones and/or joints as the number of coordinates of bones and/or joints in a control data record which can be or is received in the above-described method for animating an avatar.

In particular, the virtual model represents a human body, in particular a human head.

The movements and/or changes of a real human body, in particular a real human head, are preferably captured in this case in step b).

Movements of individual landmark points of the moving and/or changing real body are preferably detected in step b). This approach is also described, for example, in US 2013/0235045 A1, in particular in paragraphs 0061-0064.

Landmark points can be indicated, for example, on the real body, for example a face, in advance, for example by applying optical markers to defined locations on the body. Each optical marker can then be used as a landmark point. If the movements of the real body are tracked using a video camera, the movements of the optical markers can be detected in the camera image in a manner known per se and their positions relative to a reference point can be determined.

In the present context, it has been found to be particularly preferred if the landmark points are defined in the camera image by means of automatic image recognition, in particular by recognizing predefined objects, and are then preferably superimposed on the camera image. In this case, use is advantageously made of pattern or facial recognition algorithms which identify distinguished positions in the camera image and, on the basis thereof, superimpose landmark points on the camera image, for example using the Viola-Jones method. Corresponding approaches are described, for example, in the publication “Robust Real-time Object Detection”, IJCV 2001 by Viola and Jones.

However, other methods can also be used to detect the landmark points.

When carrying out the method in a web browser, a corresponding program code is preferably compiled into native machine language before execution in order to detect the landmark points. This can be carried out using an ahead-of-time compiler (AOT compiler), for example Emscripten. The detection of landmark points can be greatly accelerated as a result. For example, the program code for detecting the landmark points may be present in C, C++, Phyton or JavaScript using the OpenCV and/or OpenVX program library.

It is also possible to use other image recognition or facial recognition technologies in a flexible manner since a corresponding source code can be compiled and incorporated in a modular manner via the AOT compiler. The actual program which carries out the method can therefore remain unchanged, whereas the source code which is compiled with the AOT compiler can be adapted at any time.

In particular, the landmark points are assigned to individual vertices of the mesh of the virtual model and/or the individual landmark points are directly and/or indirectly assigned to individual control elements of the model. The landmark points can be indirectly assigned to the individual control elements of the model by linking the control elements to the vertices, for example.

Geometry data relating to the landmark points can therefore be transformed into corresponding positions of the vertices and/or of the control elements.

If the virtual model is defined by a skeleton in the form of a set of hierarchically connected bones and/or joints and a mesh of vertices which is coupled thereto, the respective positions of the bones and/or joints are preferably determined by detecting the movements of the individual landmark points of the moving and/or changing real body in step b).

In addition to the movements and/or changes of the real body, acoustic signals, in particular sound signals, are advantageously captured in a time-resolved manner in step b). This can be carried out using a microphone, for example. Voice information, for example, can therefore be captured and can be synchronized with the control data.

The control data provided in step d), in particular the time-resolved coordinates of the bones and/or joints of the model, are preferably recorded and/or stored in a time-coded manner, in particular in such a manner that they can be retrieved with a database. This makes it possible to access the control data if necessary, for example in a method for animating an avatar as described above.

If acoustic signals are concomitantly captured, the control data are preferably recorded and/or stored in a time-coded manner in parallel with the acoustic signals. The acoustic signals and the control data are therefore recorded and/or stored at the same time but separately, in particular.

In particular, steps a) to d) in the method for generating control data are carried out completely on a local data processing installation. The control data provided in step d) are preferably stored and/or recorded on a remote data processing installation in this case, possibly together with the acoustic signals.

The method for generating control data is carried out, in particular, in such a manner that the control data provided in step d) can be used as control data for the above-described method for animating an avatar.

In a further aspect, the present invention relates to a method comprising the steps of: (i) generating control data for animating an avatar using a method as described above, and (ii) animating an avatar using a method as described above. In this case, the control data generated in step (i), in particular, are received as control data in step (ii).

In one advantageous embodiment, the control data provided in step (i) are continuously received as control data in step (ii) and are used to animate the avatar and are preferably recorded and/or stored at the same time.

In this case, the control data received in step (ii) are preferably assigned to the key images, bones and/or joints of the avatar taking into account a protocol described above.

In particular, steps (i) and (ii) take place in a parallel manner, with the result that the animated avatar in step (ii) substantially simultaneously follows the movements and/or changes of the real body which are captured in step (i).

Steps (i) and (ii) are preferably carried out on the same local data processing installation. A user can therefore immediately check, in particular, whether the control data are captured in a sufficiently precise manner and whether the animation is satisfactory.

The invention also relates to a data processing system comprising means for carrying out the method for animating an avatar as described above and/or means for carrying out the method for capturing control data for animating an avatar as described above.

The data processing system comprises, in particular, a central computing unit (CPU), a memory, an output unit for presenting image information and an input unit for inputting data. The data processing system preferably also has a graphics processor (GPU), preferably with its own memory.

The system preferably also comprises means for capturing the movements and/or changes of a real body, in particular a camera and/or sensors as described above. In particular, the system also has at least one microphone for capturing acoustic signals, in particular spoken language.

The present invention likewise relates to a computer program comprising instructions which, when the program is executed by a computer, cause the latter to carry out a method for animating an avatar as described above and/or a method for capturing control data for animating an avatar as described above.

The present invention finally relates to a computer-readable storage medium on which the computer program mentioned above is stored.

As it has emerged, the approaches and methods according to the invention are particularly advantageous for creating and conveying learning contents for sales personnel.

For example, a trainer can record the presentation of his sales arguments via a video camera and can use the method according to the invention to generate control data for animating an avatar. The facial expressions and gestures particularly relevant in sales pitches can be illustrated by the trainer in this case and are concomitantly captured. This can be carried out entirely without special software in a purely web-based manner using a web application with a user-friendly and intuitive graphical user interface.

The control data can represent, for example, training sequences which are stored as fixedly assigned and structured learning content on a server accessible via the Internet and can be played back at any time. In this case, any desired number of students can access the control data at different times and can therefore animate a personally freely selectable avatar. This may again take place in a purely web-based manner using a web application with a graphical user interface which is likewise user-friendly and intuitive. Therefore, the student also does not require any additional software. In addition, the learning content can be repeated as often as desired.

It is also possible, for example, for the student himself to re-enact different sales situations and to record the latter with a video camera, which may be, for example, a web camera integrated in a laptop, and to use the method according to the invention to generate control data for animating an avatar, which control data can be locally stored on the student's computer, from where the student can then conveniently select, load and play back said data via a web presenter. In this case, the student can use the control data to animate an avatar, for example, which reflects the sales situation. On the basis of this animation, the student can identify any possible weak points in his appearance and can improve them.

It is also conceivable for the sales situation re-enacted by the student to be assessed by another person, for example the trainer, in order to provide the student with feedback.

Further advantageous embodiments and combinations of features of the invention emerge from the following detailed description and all of the patent claims.

### BRIEF DESCRIPTION OF THE DRAWINGS

In the drawings used to explain the exemplary embodiment:

FIG. 1 shows a flowchart which illustrates a method according to the invention for animating an avatar using a data processing device;

FIG. 2 shows the graphical user interface of a web-based program for animating an avatar, which is based on the method illustrated in FIG. 1;

FIG. 3 shows a flowchart which illustrates a method according to the invention for capturing control data for animating an avatar using a data processing device;

FIG. 4 shows the graphical user interface of a web-based program for capturing control data for animating an avatar, which is based on the method illustrated in FIG. 3;

FIG. 5 shows a schematic illustration of an arrangement comprising three data processing installations which communicate via a network connection, which arrangement is designed to execute the methods or programs illustrated in FIGS. 1-4;

FIG. 6 shows a variant of the web-based program for animating an avatar from FIG. 2 which is designed for training or education;

FIG. 7 shows a variant of the web presenter or the user interface from FIG. 2 which is designed for mobile devices having touch-sensitive screens.

In principle, identical parts are provided with identical reference signs in the figures.

### WAYS OF IMPLEMENTING THE INVENTION

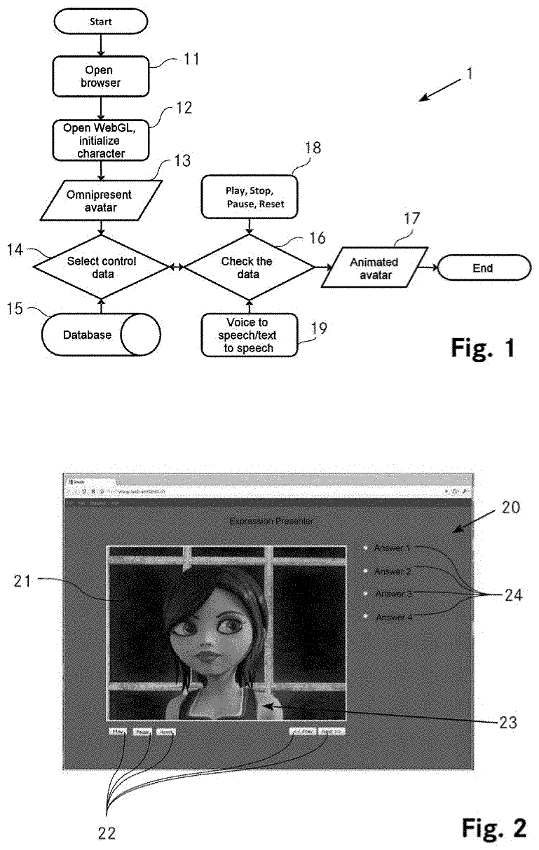

FIG. 1 shows a flowchart 1 which illustrates, by way of example, a method according to the invention for animating an avatar using a data processing device.

In a first step 11, a program for animating the avatar, which is provided as a web application on a web server, is started by calling up a website in a web browser. In this case, a web browser having WebGL support, for example Chrome (Google), is used.

In a next step 12, WebGL is opened and a container on a website is configured by means of JavaScript in such a manner that its contents are distinguished from the rest of the website. The result is a defined area within which programs can now run separately. Various elements of WebGL are now integrated in this area (screen section), for example a 3-D scene as a basic element, a camera perspective of this, different lights and a rendering engine. If such a basic element has been created, different additional elements can be loaded into this scene and positioned. This takes place via a number of loaders which provide and support WebGL or its frameworks.

Loaders are programs which translate the appropriate technical standards into the method of operation of WebGL and integrate them in such a manner that they can be interpreted, presented and used by WebGL. In the present case, the loaders are based on the JavaScript program libraries ImageLoader, JSONLoader, AudioLoader and AnimationLoader from three.js (release r90, Feb. 14, 2018) which have been specifically expanded, with the result that the specific BVH control data can be loaded, interpreted and connected to an avatar with the inclusion of an assignment protocol.

In step 12, a character or an avatar, for example in the form of a head, can therefore be initialized. In this case, the avatar is defined by a virtual model in the form of a three-dimensional skeleton comprising a set of hierarchically connected bones, for example a number of 250, and a mesh of vertices which is coupled thereto, and is loaded into a memory area which can be addressed by a graphics unit of the program. The avatar may be present in the format JSON, gITF2 or COLLADA and is loaded together with key images of the avatar, for example 87 key images.

Furthermore, a protocol is loaded into the memory area in step 12, which protocol can be used to assign control data arriving via a receiving unit of the program to one or more bones and/or key images of the avatar.

An omnipresent avatar 13 is therefore provided and is available, together with the protocol, during the entire runtime of the program and can be presented in a canvas or container 21 (see FIG. 2) on a screen. In this starting position, the avatar can receive control data at any time via the receiving unit of the program.

In step 14, control data can now be selected from a database 15 available on a remote web server via conventional user interfaces provided by the program for animating the avatar and can be transferred via the Internet.

In this case, the control data comprise a plurality of control data records, wherein each control data record defines the avatar at a particular time. A control data record comprises the time-coded three-dimensional coordinates of 40 bones, for example, which is fewer than the number of 250 bones included in the avatar loaded into the memory area. The control data are present, in particular, in a BVH data format which contains the bone hierarchy and the motion data in the form of coordinates. In this case, each line of the motion data defines the avatar at a defined time.

In step 16, any desired data streams of control data, which cause the avatar to move, can be initiated and checked via common HTML5 or CSS control elements 22, 24 (see FIG. 2) which are provided by the program for animating the avatar. All conceivable sequences can therefore be constructed. The data streams may also comprise check data 18, 19, for example data for starting (play), stopping (stop), pausing (pause), resetting (reset) and selecting options. The check data may also be generated from text inputs (text to speech) or voices (voice to speech).

As soon as control data arrive, they are transferred, via the receiving unit of the program for animating the avatar, to the graphics unit which continuously recalculates an updated avatar on the basis of the respectively currently transferred control data with subsequent rendering of the updated avatar and presents the latter in the web browser on the screen in the form of an animated avatar 17. This is carried out as follows:
(i) transferring a first received control data record to the graphics unit;
(ii) calculating an updated avatar on the basis of the transferred control data record and rendering the avatar in the graphics unit taking into account the protocol. The coordinates of selected bones in the control data are specifically assigned to a key image or to one or more bones. Corresponding intermediate images are calculated by means of interpolation taking into account the key images;
(iii) presenting the updated avatar in the web browser on the screen;
(iv) transferring a next received control data record to the graphics unit;
(v) repeating steps (ii) to (iv).

This is continued until the user ends the program for animating an avatar. Substeps (i) to (iv) take place in sync with the time-coded control data, with the result that a real-time animation is produced. A repetition rate of substeps (i) to (iv) is approximately 30 Hz, for example.

On account of the low data volumes, the avatar can be animated without any problems on mobile devices such as smartphones or tablets, while the control data are obtained from remote web servers via Internet connections.

FIG. 2 shows the graphical user interface 20 of the program for animating the avatar, which was described in connection with FIG. 1 and is executed in a web browser. In this case, an avatar 23 is presented against a background in a canvas 21 in the web browser. In this case, the avatar 23 corresponds to a representation of the omnipresent avatar 13 which becomes an animated avatar 17 when control data arrive, as described above. For control, the graphical user interface 20 has HTML5 or CSS control elements 22, 24 in the form of buttons and selection fields.

The method described in connection with FIGS. 1 and 2 is therefore a web presenter which can be implemented as a pure web application or in the form of a website and, after the loading operation, can be completely executed on a local data processing installation.

The user can also integrate such a web presenter in his own website as follows, for example: the user downloads a software module (plug-in) for his content management system (CMS) on a defined website and incorporates it into his backend.

The user can then define the appearance of the design of the web presenter on his site (=front-end) and can define where which control elements and how many control elements are intended to be placed. The user can also define which control unit is intended to be provided with which dynamic text and creates the latter. Finally, he addresses the control unit, for example a button with the storage location of control data generated in advance (for example BVH and audio). As soon as the button is operated, an avatar which was defined and/or selected in advance and was loaded with the opening of the website is animated using the arriving control data. In this case, subtitles, text and images, for example, can be displayed individually and in a time-controlled manner as desired.

The graphical user interface 20, as illustrated in FIG. 2, is suitable, in particular, for the direct sale of products or services or for carrying out online tests. The avatar can directly ask a customer or a test subject questions which can be answered by the customer or test subject via the control elements 24 in the form of selection fields.

After a selection or answer, the customer presses the button “Next” of the control elements 22 and the avatar asks the next question, etc. All answers can be individually evaluated in a manner corresponding to the wishes of the customer or in a manner corresponding to the answers from the test subject, with the result that a text document in the form of a bid or a test evaluation can be created thereby, for example.

The control elements can be expanded in any desired manner and can be linked in a manner corresponding to the wishes of the user or service provider.

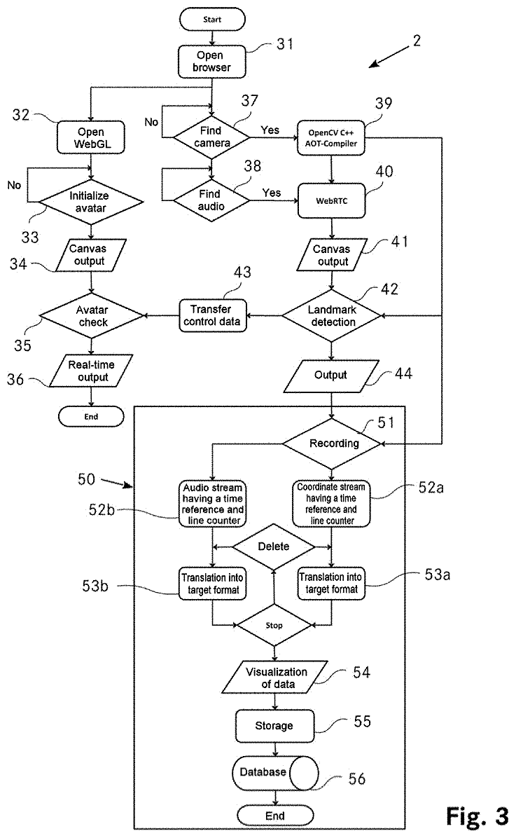

FIG. 3 shows a second flowchart 2 which illustrates, by way of example, a method according to the invention for capturing control data for animating an avatar using a data processing device.

In a first step 31, a program for capturing control data for animating an avatar, which is provided as a web application on a web server, is started by calling up a website in a web browser. A web browser having WebGL and WebRTC support, for example Chrome (Google), is used in this case, in particular.

In a next step 32, WebGL is opened and JavaScript is used to configure a canvas on a website in such a manner that its contents are distinguished from the rest of the website.

In step 33, a character or an avatar, for example in the form of a head, is then selected and initialized. In this case, the avatar is defined as described above in connection with FIG. 1 and is loaded, together with associated key images of the avatar, for example 87 key images, into a memory area which can be addressed by a graphics unit of the program. Accordingly, the avatar is present in the memory area as a virtual model in the form of a three-dimensional skeleton having, for example, 250 hierarchically connected bones and a mesh of vertices which is coupled thereto. Furthermore, a protocol which can be used to assign control data arriving via a receiving unit of the program to one or more bones and/or key images of the avatar is loaded into the memory area.

In step 34, the avatar is then output in the canvas on the website.

The avatar provided in this manner can now receive, in the subsequent step 35, control data in the form of coordinates or control data generated in advance. As soon as control data arrive, they are transferred, as described in FIG. 1, via a receiving unit of the program for animating the avatar, to the graphics unit which continuously recalculates an updated avatar on the basis of the respectively currently transferred control data with subsequent rendering of the updated avatar and presents the latter in the web browser on the screen in the form of an animated avatar 36.

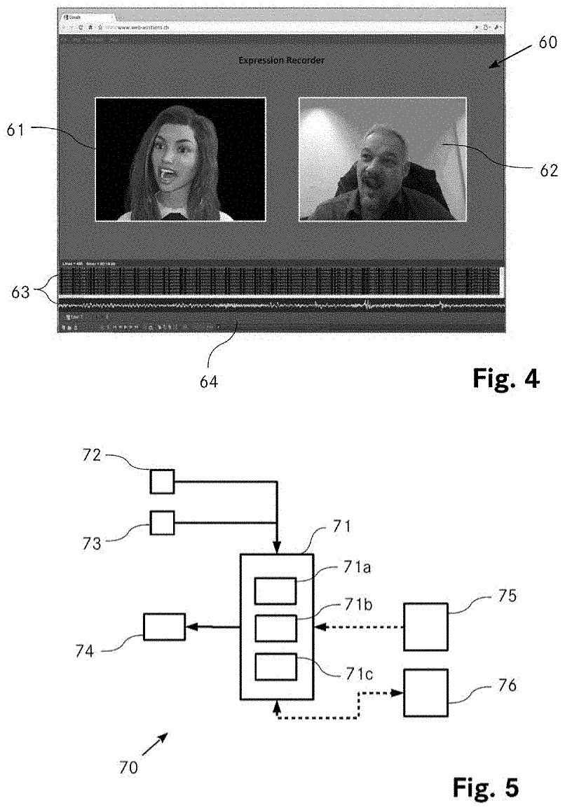

An omnipresent avatar is therefore provided and is available, together with the protocol, during the entire runtime of the program and can be presented in a canvas (see FIG. 4, canvas 61) on a screen. In this starting position, the avatar can follow the movements of a real person, which are captured in a process taking place in a parallel manner and are converted into control data (see description below), in real time. It is also possible for the omnipresently available avatar to be animated using control data which are stored in advance and are stored in a database.

In parallel with step 32, possible camera connections are searched for and initialized in step 37. In this case, it is possible to use, for example, cameras which make it possible to establish an online connection to the web browser. Web cameras or webcams are particularly suitable. In addition, possible audio input channels are searched for and initialized in step 38.

In step 39, the program code for landmark point detection which is present in C++ is compiled via Emscripten or another ahead-of-time compiler using OpenCV, is provided as asm.js intermediate code and is started. The speed of the program code for landmark point detection can therefore be greatly accelerated. The program code for landmark point detection may be based, for example, on a Viola-Jones method.

The camera and audio data are transferred to WebRTC and incorporated in step 40. The associated output is presented in a canvas (see FIG. 4, canvas 62) on the screen in the web browser in step 41. The result is a real-time video stream having a multiplicity of defined landmark points. These follow every movement of a real person captured by the camera.

In step 42, all coordinates of the landmark points changing in space are calculated with respect to defined zero or reference points and are output as dynamic values in the background. In this case, the landmark points are assigned to individual vertices of the mesh of a virtual model of the real person. The landmark points are therefore assigned to the coordinates of the control elements of the virtual model by linking the vertices to the individual control elements.

In a similar manner to the avatar, the virtual model of the real person is also defined by a skeleton in the form of a set of hierarchically connected bones and/or joints and a mesh of vertices which is coupled thereto. However, this virtual model has fewer control elements than the virtual model of the avatar. For example, the virtual model of the real person comprises only 40 bones, whereas the virtual model of the avatar comprises 250 bones. As described above, the control elements of the virtual model of the real person can be specifically assigned to the control elements and key images of the avatar by using a protocol.

The dynamic control data or coordinates are transferred, in step 43, to the avatar which is accordingly animated (see above, steps 35 and 36). The avatar therefore follows the movements of the real person in real time. This is used to check whether the movements of the real person are captured correctly and are converted into corresponding control data.

In a parallel manner, the control data generated can be output in step 44 for the purpose of further processing or storage.

In order to store the control data, the control data output in step 44 are supplied to an integrated recorder unit 50. In this case, a recording can be started in step 51. During the recording, all incoming motion data or the control data or coordinates (coordinate stream) are provided with a time reference in step 52a and are synchronized with a time line. The volume of data is then counted.

At the same time, the audio data (audio stream) are also provided with the time reference in step 52b and are synchronized with the time line.

All motion data are now directly transferred to an arbitrary format, in particular BVH control data, in step 53a. At the same time, all audio data are transferred to an arbitrary audio format in step 53b. Formats which generate relatively low volumes of data at high equality, for example MP3 formats, are preferred.

The data provided can be visibly output in step 54. This enables checking and is used for possible adjustments.

The data are then stored together in step 55, for example using a database 56, with the result that they can be retrieved at any time. In this case, the stored data contain the control data in a format which makes it possible to use said data in a method for animating an avatar according to FIGS. 1 and 2. The storage can be checked, for example, by means of special control elements which are made available to a user on a graphical interface (see FIG. 4).

The method described in connection with FIGS. 3 and 4 is implemented as a pure web application.

Steps 31-54 preferably take place on a local data processing installation, for example a desktop computer of the user with a web camera, whereas step 55 or the storage takes place on a remote data processing installation, for example a web server.

The storage volume of the data, including audio data, is on average approximately 20 MB per minute of an animation, which is extremely low. For comparison: a storage volume of approximately 100 MB/min is typically expected with the currently widespread high-resolution videos (HD, 720p).

FIG. 4 shows the graphical user interface 60 of the program for generating control data, which program was described in connection with FIG. 3 and is executed in a web browser. On the left-hand side, the avatar animated in step 36 (FIG. 3) is presented in a first canvas 61 in the web browser. The real-time video stream which is output in step 41 (FIG. 3) and has a multiplicity of defined landmark points is presented on the right-hand side in FIG. 4.

The control data or coordinates and audio data output in step 54 (FIG. 3) are presented in a further canvas 63 in the regions underneath. Control elements 64 which can be used to control the method for generating control data are arranged below canvas 63. In this case, a recording button, a stop button and a delete button can be provided, for example.

The method described in connection with FIGS. 3 and 4 constitutes a web recorder which is implemented as a pure web application or in the form of a website and, apart from the storage of the control data, can be executed substantially completely on a local data processing installation after the loading operation.

Specifically, the use of the web recorder from the point of view of the user is as follows, for example: a user opens the web browser on his local computer and inputs the URL (Uniform Resource Locator) of the website which provides the web recorder.

After an optional log-in, the graphical user interface 60 having a rendered avatar selected in advance appears on the left-hand side of the screen in the canvas 61. The face of the user with the applied landmark points, which follow every movement of the face, is presented, for example, on the right-hand side of the screen in the canvas 62 by enabling the web camera and microphone on the computer. Since movements are transmitted directly to the avatar, the latter automatically follows every movement of the user's face.

If the user is satisfied with the result, he presses a recording button in the region of the control elements 64, whereupon a recording is started. If the user then presses a stop button, the generated control data and the audio data are stored after selecting a storage location and allocating the file name. If the user now presses a delete button, the web recorder is ready for a next recording.

The web recorder can therefore be provided and operated as a pure web application. There is no need to install additional software.

The web recorder may be provided online, for example, via a platform with a license fee with corresponding accounting, with the result that web designers or game developers can themselves record their control data, for example.

The matter is of particular interest to web designers since the presenter can be integrated in any desired website in the form of a CMS plug-in, can be freely configured and connected, with the result that an unlimited number of a wide variety of applications can be quickly implemented. These plug-ins and a multiplicity of different avatars can then be simply downloaded from the platform.

FIG. 5 schematically shows an arrangement 70 comprising a first data processing installation 71, for example a desktop computer, having a processor 71a, a main memory 71b and a graphics card 71c with a graphics processor and a graphics memory. Connected thereto are a video camera (webcam) 72, a microphone 73 and a screen with integrated loudspeakers.

The data processing installation 71 also has interfaces with which it can obtain data from a second and remote data processing installation 75 and can transmit data to a third and remote data processing installation 76. The second data processing installation 75 may be, for example, a web server on which avatars, together with associated key images and assignment protocols, are stored in a retrievable manner. The third data processing installation 76 may likewise be a web server on which generated control data are stored and/or from which said control data are retrieved again.

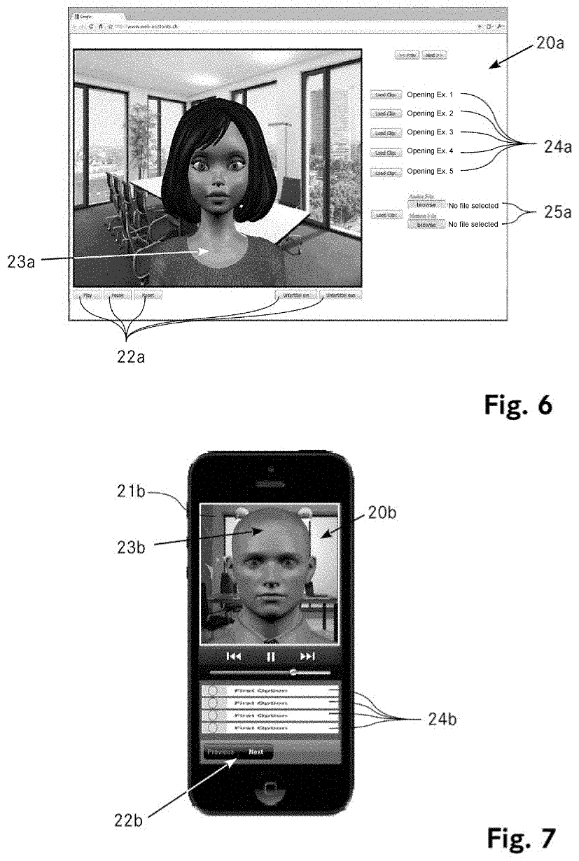

FIG. 6 shows a variant of the web presenter or the user interface from FIG. 2. The user interface 20a of the web presenter from FIG. 6 is designed, in particular, as a variant for training or education. In this case, an avatar 23a is again presented against a background in a canvas 21a in the web browser. The avatar 23a likewise corresponds to a representation of the omnipresent avatar 13 which becomes an animated avatar 17 when control data arrive, as is described above. For control, the graphical user interface 20a has HTML5 or CSS control elements 22a, 24a, 25a in the form of buttons.

During use, a student navigates, for example, to the topic of “open conversation in a sales pitch” where the student is offered five professional exemplary arguments which can be selected via the control elements 24a and can then be played back via the control elements 22a. The animated avatar 23a then shows the student how the student can set about opening a conversation in a sales pitch. Overall, several hundred exemplary arguments which cover all relevant topics may be available. As a result, the student is provided with an impression of what he himself must work on. The design of the user interface can be configured in any desired manner.

During the animation, the student can make notes and can work on his own arguments. He can then present these arguments for the sake of practice and can himself record and store control data using a web camera and a microphone with a web recorder described above. The student can store the generated control data from the web recorder locally in any desired directory.

These self-produced control data can then be selected from the web presenter via the control elements 25a and can be loaded at any time. By virtue of the student playing back the control data generated by himself, the student can create a realistic image of himself and of his work through the facial expressions of the avatar 23a and the voice content. In this case, the student can change over between the predefined training content and his own production in any desired manner, which additionally enhances the learning effect.

The student can also send the control data, by email or in another manner, to a trainer who can load and assess said data at any time using a web presenter.

Since the student must look into the camera or at least at the screen during his own recordings, it is necessary, in principle, for the student to have also learnt by heart the learned material. The student can therefore make a good recording only when the student can reproduce the material without having to read it. This results in the student also being able to better use the learned material in practice, for example with a customer.

FIG. 7 shows a further variant of the web presenter or the user interface from FIG. 2. The user interface 20b of the web presenter from FIG. 7 is designed for mobile devices having touch-sensitive screens. In this case, an avatar 23b is again presented against a background in a canvas 21b in the web browser or a special application. The avatar 23b likewise corresponds to a representation of the omnipresent avatar 13 which becomes an animated avatar 17 when control data arrive, as described above. For control, the graphical user interface 20b has HTML5 or CSS control elements 22b, 24b in the form of button fields. The method of operation corresponds to the user interface or the web presenter from FIG. 2.

The exemplary embodiments described above should not be understood as being restrictive in any way and can be applied in any desired manner within the scope of the invention.

For example, it is possible for the programs which make it possible to carry out the methods described in connection with FIGS. 1-4 to be stored locally on the data processing installation, rather than as a web application, and to be started locally.

It is also possible, in the methods described in FIGS. 1-2, for the control data to be received from a local database which is on the same data processing installation on which the method is also carried out.

Likewise, in the methods described in FIGS. 3-4, the control data can be stored in a local database which is on the same data processing installation on which the method is also carried out.

With respect to the methods described in connection with FIGS. 3-4, it is also possible, in principle, to omit steps 32-36 and 43 if there is no need to immediately check the control data. In this case, it is also possible to dispense with the canvas 61 in the user interface 60 in FIG. 4.

In the arrangement 70 in FIG. 5, it is alternatively or additionally possible to also use other output devices, for example projectors or holographs, instead of a screen 74, for example.

It is also possible, in the arrangement in FIG. 5, to use a mobile device, for example a laptop, a tablet or a mobile telephone with appropriate functionalities, as a first data processing installation.

In summary, it can be stated that novel and particularly advantageous methods and programs have been provided and can be used to efficiently generate control data for avatars and to animate avatars. In this case, the control data used in the methods have only a low volume of data, with the result that they can be very quickly transmitted from a server to a client without unnecessarily loading the networks. Therefore, additional contents, for example further animations for the background, etc., can be transmitted, which results in further possible applications.

With the control data, 2-D or 3-D avatars in the form of virtual assistants for training, sales, advice, games and the like can be used, in particular.

The production time for an animation is immensely reduced as a result and can be carried out by laypersons since no specific expert knowledge is required. No programs need to be installed.

1-34. (canceled)

35. A computer-implemented method for animating an avatar using a data processing device, comprising the steps of:
a) providing a graphics unit which is designed to animate two-dimensional and/or three-dimensional objects and has an interface, via which control data for animating the two-dimensional and/or three-dimensional objects can be transferred to the graphics unit;
b) loading and keeping an avatar available in a memory area which can be addressed by the graphics unit;
c) providing a receiving unit for receiving control data for animating the avatar;
d) continuously and sequentially transferring received control data to the graphics unit;
e) animating the avatar by continuously recalculating an updated avatar on the basis of the respectively currently transferred control data with subsequent rendering of the avatar in the graphics unit;
f) continuously presenting the updated avatar on an output device.
whereby the method is carried out in a web browser running on the data processing installation.

36. The method as claimed in claim 35, whereby the avatar is omnipresently available in the memory area during steps d) to f).

37. The method as claimed in claim 35, whereby steps d) to f) are carried out in real time.

38. The method as claimed in claim 35, whereby the control data have time coding and steps d) to f) are preferably executed in sync with the time coding.

39. The method as claimed in claim 35, whereby the avatar is defined by a skeleton in the form of a set of hierarchically connected bones and/or joints and a mesh of vertices which is coupled thereto, and the control data represent coordinates of the bones and/or joints.

40. The method as claimed in claim 35, whereby key images of the avatar, for example 10-90 key images, are loaded into the memory area and are provided together with the avatar.

41. The method as claimed in claim 35, wherein the control data comprise one or more control data records, wherein a control data record defines the avatar at a particular time.

42. The method as claimed in claim 41, whereby a control data record contains the coordinates of n bones and/or joints, whereas the avatar comprises more than n bones and/or joints, wherein one of the more than n bones and/or joints of the avatar is assigned to each of the n bones contained in a control data record.

43. The method as claimed in claim 40, whereby when calculating the updated avatar, intermediate images are generated by interpolating at least two key images, and
whereby at least one key image or a plurality of key images, is/are linked to a selected bone and/or joint in the control data in step e), and
whereby a position of a selected bone and/or joint in the control data is assigned to an intermediate image which is obtained by means of interpolation using the at least one linked key image, and
whereby a deviation of the position of a selected bone from a predefined reference value defines the strength of the influence of the at least one linked key image in the interpolation.

44. The method as claimed in claim 40, whereby the individual control data are assigned to the bones and/or joints of the avatar and/or to the key images according to a predefined protocol, wherein the protocol is preferably loaded into the memory area and provided together with the avatar.

45. The method as claimed in claim 35, whereby the control data are present on a remote data processing installation and are received therefrom via a network connection.

46. The method as claimed in claim 35, whereby two or more avatars are simultaneously loaded and kept available independently of one another and are preferably animated independently of one another using individually assigned control data.

47. A method for capturing control data for animating an avatar using a data processing device comprising the steps of:
a) providing a two-dimensional or three-dimensional virtual model of a body, which can be moved in a two-dimensional or three-dimensional space, wherein the model has control elements which can be used to do change the virtual model in a defined manner;
b) capturing the movements and/or changes of a real body in a time-resolved manner;
c) emulating the movements and/or changes of the real body in the virtual model by determining the coordinates of the control elements of the virtual model, which correspond to a state of the real body at a given time, in a time-resolved manner;
d) providing the determined time-resolved coordinates of the control elements as control data.
whereby the method is carried out in a web browser running on the data processing installation.

48. The method as claimed in claim 47, whereby steps b) to d) are carried out in real time.

49. The method as claimed in claim 47, whereby the coordinates of all control elements at a defined time form a data record which completely defines the model at the defined time.

50. The method as claimed in claim 47, whereby the virtual model is defined by a skeleton in the form of a set of hierarchically connected bones and/or joints and a mesh of vertices which is coupled thereto, wherein the bones and/or joints constitute the control elements.

51. The method as claimed in claim 47, whereby the virtual model represents a human body, and the movements and/or changes of a human body are captured in step b).

52. The method as claimed in claim 47, whereby movements of individual landmark points of the moving and/or changing real body are detected in step b).

53. The method as claimed in claim 52, whereby the landmark points are assigned to individual vertices of the mesh of the model.

54. The method as claimed in claim 47, whereby a 2-D video camera is used in step b) when capturing the movements and/or changes of the body.

55. The method as claimed in claim 47, whereby, in addition to the movements and/or changes of the real body, acoustic signals are captured in a time-resolved manner in step b).

56. The method as claimed in claim 47, whereby the control data provided in step d) are recorded and/or stored in a time-coded manner.

57. The method as claimed in claim 56, whereby the control data are recorded and/or stored in a time-coded manner in parallel with the acoustic signals.

58. The method as claimed in claim 47, whereby steps a) to d) are carried out completely on a local data processing installation and the control data provided in step d) are stored on a remote data processing installation.

59. The method as claimed in claim 35 comprising the steps of: (i) generating control data for animating an avatar, and (ii) animating an avatar, wherein the control data provided in step (i) are continuously received as control data in step (ii) and are used to animate the avatar.

60. A data processing system comprising means for carrying out the method as claimed in claim 35.

61. A data processing system comprising means for carrying out the method as claimed in claim 47.
